(19) United States
(12) Patent Application Publication
(10) Pub. No.: US 2015/0175170 A1
(43) Pub. Date: Jun. 25, 2015

(54) ELECTRONIC CONTROL UNIT

(71) Applicant: DENSO CORPORATION, Kariya-city (JP)

(72) Inventor: Mitsuru AOKI, Anjo-city (JP)

(21) Appl. No.: 14/520,482

(22) Filed: Oct. 22, 2014

(30) Foreign Application Priority Data
Dec. 20, 2013 (JP) 2013-263348

(51) Int. Cl. B60W 50/00

(52) U.S. Cl. CPC B60W 50/00; B60W 2050/0001

(57) ABSTRACT

An ECU for controlling a system providing a safety function with a high-order ASIL and for providing safety mechanisms with low-order ASILs includes: CPUs including first and second CPUs; a memory; and an anti-interference device. Each CPU executes first and second monitoring functions according to the low-order ASILs. The first monitoring function provides to monitor whether a control function of the system is properly executed, and the second monitoring function provides to monitor whether the first monitoring function is properly executed. The memory has a first area for the first CPU and a second area for the second CPU. The anti-interference device executes a prevention of an interference or a record of a history of the interference. The interference includes a first interference provided to the second area by the first CPU and a second interference provided to the first area by the second CPU.

### CROSS REFERENCE TO RELATED APPLICATION

This application is based on Japanese Patent Application No. 2013-263348 filed on Dec. 20, 2013, the disclosure of which is incorporated herein by reference.

### TECHNICAL FIELD

The present disclosure relates to an electronic control unit.

### BACKGROUND

In automobiles, a large number of in-vehicle apparatuses, such as brake, steering, and engine, are electronically controlled by an electronic control unit. In conjunction with the proliferation of electric vehicles and hybrid vehicles, it is expected that the targets of electronic control, such as motor control and battery control, will be increased in the future. For this reason, ISO 26262, a functional safety standard for automobiles was established to ensure safety when an automobile is electronically controlled.

In ISO 26262, each electronically controlled system is ranked based on a hazardous event (hazard) that may occur when the functions of the system become faulty. This ranking is carried out by three parameters, hazard level, the frequency of occurrence, and controllability (the degree of difficulty of avoidance) using an index called ASIL (Automotive Safety Integrity Level). As ASIL, five ranks, QM (Quality Management), A, B, C, and D in ascending order of risk, are laid down. A designer of a system is required to determine to which rank the system is equivalent and take a safety measure corresponding to the determined rank.

A case where some system is ranked “C” of ASIL will be taken as an example. In this case, as described in Patent Document 1, the following configuration may be adopted: a configuration in which the electronic control unit electronically controlling that system is divided into three levels and the operation at a higher level is monitored at a lower level. In this electronic control unit in Patent Document 1, the first level is in charge of the control functions of the system. Specifically, at the first level, determination is made with respect to fuel supply to an internal combustion engine or the adjustment of ignition timing. At the second level, the correctness of the performance of the control functions at the first level is inspected based on a selected input/output signal. At the third level, the monitoring carried out at the second level is inspected. Specifically, for example, a RAM test, a ROM test, a performance test, and the like are carried out. A watchdog is provided for this performance test at the third level.

When a system is ranked some rank of ASIL as mentioned above, hardware and software are designed to take a safety measure corresponding to that rank in the electronic control unit. Therefore, it is required to redesign the hardware and software of the electronic control unit so as to meet safety requirements according to a higher ASIL rank in the following cases: a case where a system of a higher ASIL rank than an existing system is newly integrated; and a case where the ASIL rank of a system is changed to a higher rank because of a difference in the vehicle equipped with the system or the like. In these cases, there is the possibility that the development cost will be increased.

Patent Document 1: Japanese Patent No. 3957749 (corresponding to U.S. Pat. No. 5,880,568 A)

### SUMMARY

It is an object of the present disclosure to provide an electronic control unit in which safety requirements according to a higher ASIL rank can be met without any significant design change.

According to an aspect of the present disclosure, an electronic control unit electronically controls a system, which provides a safety function having a high-order automotive safety integrity level, and provides a plurality of safety mechanisms having a plurality of low-order automotive safety integrity levels respectively, which are decomposed from the high-order automotive safety integrity level. The electronic control unit includes: a plurality of central processing units including a first central processing unit and a second central processing unit; a memory that is commonly utilized by the plurality of central processing units; and an anti-interference device. Each of the first central processing unit and the second central processing unit executes a first monitoring function and a second monitoring function as a safety mechanism according to the low-order automotive safety integrity levels, respectively. The first monitoring function provides to monitor whether a control function of the system is properly executed. The second monitoring function provides to monitor whether the first monitoring function is properly executed. The memory have a first area, which is utilized by the first central processing unit to execute each of the first monitoring function and the second monitoring function, and a second area, which is utilized by the second central processing unit to execute each of the first monitoring function and the second monitoring function. The first area is different from the second area. The anti-interference device executes at least one of a prevention of an interference and a record of a history of the interference. The interference includes a first interference, which is provided to the second area by the first central processing unit when the first central processing unit executes each of the first monitoring function and the second monitoring function, and a second interference, which is provided to the first area by the second central processing unit when the second central processing unit executes each of the first monitoring function and the second monitoring function.

In the above case, as mentioned above, first, a higher-order safety integrity level is decomposed into a plurality of lower-order safety integrity levels by utilizing the concept of decomposition in ISO 26262. For example, ASIL-D can be decomposed into ASIL-C and ASIL-A, and ASIL-C can be decomposed into ASIL-B and ASIL-A. As mentioned above, decomposition can be utilized to lower the rank of a safety integrity level. For this reason, when a safety mechanism is built for a system required to ensure functional safety according to a higher-order safety integrity level, the following can be implemented: it is possible to enhance the reusability of hardware and software designed to meet safety requirements according to a lower-order safety integrity level.

When decomposition is carried out, however, it is required to ensure the independence of decomposed elements. To do this, a safety mechanism based on decomposed lower-order safety integrity levels could be individually built in independent separate electronic control units. However, use of separate electronic control units as mentioned above involves a problem of increased cost and physical size.

In the above case, consequently, an electronic control unit having a plurality of CPUs including a first CPU and a second CPU is used. Each of the first CPU and the second CPU carries out the following functions as a safety mechanism based on a plurality of decomposed lower-order safety integrity levels: a first monitoring function for monitoring whether the control function of the system is correctly carried out; and a second monitoring function for monitoring whether the first monitoring function is correctly working. This makes it possible to ensure a certain measure of independence as a safety mechanism based on the decomposed lower-order safety integrity levels.

In case of a single electronic control unit, even though a plurality of CPUs are provided, memories are used by the CPUs in a shared manner. Therefore, should data required for the execution of a monitoring function by one safety mechanism be read or rewritten in conjunction with the execution of a monitoring function by the other safety mechanism, the following takes place: there is the possibility that a monitoring function will not correctly work. To cope with this, in the present case, an anti-interference device is provided, to prevent the following interference or to record the history of occurrence of interference: interference with the second area of a memory in conjunction with the execution of each monitoring function by the first CPU; and interference with the first area of a memory in conjunction with the execution of each monitoring function by the second CPU. As a result, it is possible to prevent the occurrence of the above-mentioned event and cause each monitoring function to correctly work without fail. Or, when interference occurs, the history thereof can be kept; therefore, a safety measure, such as system stop, can be taken.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block configuration diagram illustrating the functions carried out by each CPU of an electronic control unit in an embodiment on a block-by-block basis;

FIG. 2 is a configuration diagram illustrating major components of an electronic control unit;

FIG. 3 is a block configuration diagram illustrating the functions carried out by each CPU of an electronic control unit in a first modification on a block-by-block basis;

FIG. 4 is a block configuration diagram illustrating the functions carried out by each CPU of an electronic control unit in a second modification on a block-by-block basis; and

FIG. 5 is a block configuration diagram illustrating the functions carried out by each CPU of an electronic control unit in a third modification on a block-by-block basis.

### DETAILED DESCRIPTION

Hereafter, a description will be given to an electronic control unit in an embodiment of the present disclosure with reference to the drawings. In the following description, common components will be marked with the same reference numerals and a description thereof may be omitted.

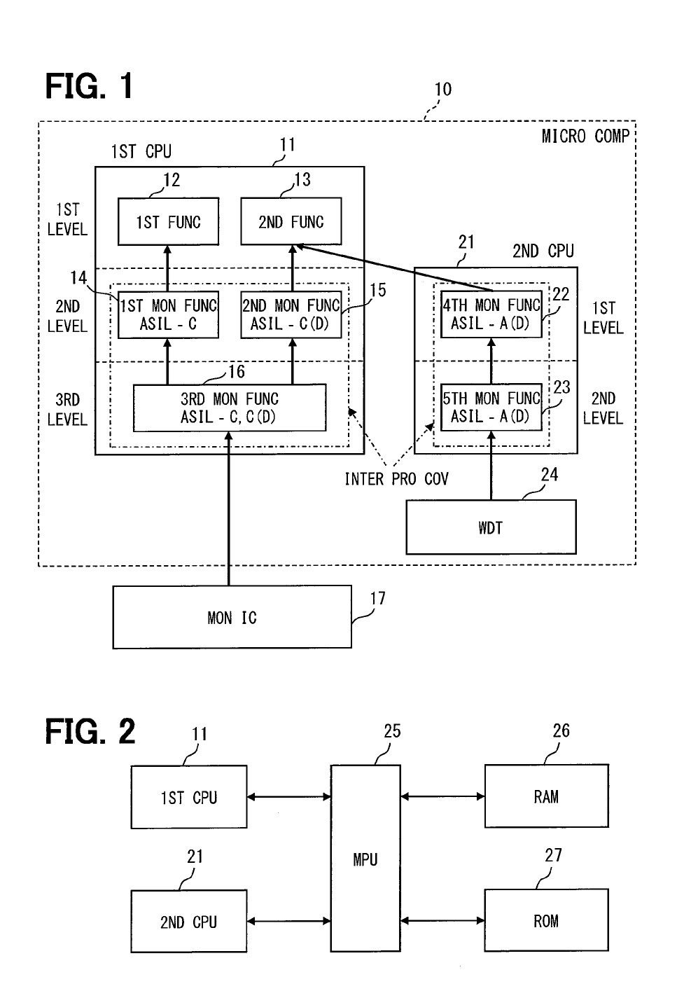

FIG. 1 illustrates the functions carried out by each CPU 11, 21 of the electronic control unit (microcomputer) 10 on a block-by-block basis. FIG. 2 illustrates major components of the microcomputer 10.

The microcomputer 10 in this embodiment is for electronically controlling an in-vehicle apparatus, such as brake, steering, and engine. For example, when the microcomputer 10 electronically controls a braking device, it controls the breaking pressure applied to each wheel by the braking device to prevent the occurrence of locking during braking or slipping during acceleration. When the microcomputer 10 electronically controls a power steering device, it controls the device so that appropriate auxiliary steering torque acts on the steering shaft. When the microcomputer 10 electronically controls an engine, it controls a fuel injection valve or an ignition coil so that fuel injection or ignition is appropriately carried out based on the operating state of the vehicle. The electronic control unit may electronically control any other in-vehicle apparatus.

Such a system electrically controlling an in-vehicle apparatus as described above is required to meet a functional safety standard established as ISO 26262. A case where the ASIL rank of an existing system is ASIL-C and the ASIL rank of a system newly integrated into the existing system is ASIL-D higher than it will be taken as an example. In this case, it is required to redesign the hardware and software of the electronic control unit to meet the safety requirements according to the higher ASIL rank. A case where the ASIL rank of an existing system is ASIL-C but the ASIL rank is changed to ASIL-D because of a difference in the applied car model or the like will be taken as an example. Also in this case, it is similarly required to redesign the hardware and software of the electronic control unit. However, when the hardware and software of the electronic control unit are entirely redesigned, a large amount of labor is required and this increases the development cost.

Consequently, this embodiment is so configured that safety requirements according to a higher-order ASIL rank can be met without entirely redesigning the hardware or software of the electronic control unit.

For this purpose, in this embodiment, an electronic control unit having a plurality of CPUs including a first CPU 11 and a second CPU 21 is used as illustrated in FIG. 1. Though FIG. 1 depicts only two CPUs, the number of CPUs may be three or more.

Utilizing the concept of decomposition in ISO 26262, a higher-order safety integrity level is decomposed into a plurality of lower-order safety integrity levels; and safety mechanisms according to the decomposed lower-order safety integrity levels are incorporated into each of the first CPU 11 and the second CPU 21. FIG. 1 shows an example in which ASIL-D is decomposed into ASIL-C(D) and ASIL-A(D) and a safety mechanism of ASIL-C(D) is incorporated into the first CPU 11 and a safety mechanism of ASIL-A(D) is incorporated into the second CPU 21.

As mentioned above, the rank of a safety integrity level can be lowered by utilizing decomposition. For this reason, when a safety mechanism is built for a system required to ensure functional safety according to a higher-order safety integrity level, the following can be implemented: the reusability of hardware and software designed to meet safety requirements according to a lower-order safety integrity level can be enhanced.

Hereafter, a detailed description will be given to the example illustrated in FIG. 1 and technical features of the electronic control unit in this embodiment will be thereby further made apparent.

As illustrated in FIG. 1, the first CPU 11 has a three-level structure. At the first level of the first CPU 11, a first function 12 and a second function 13 are allocated. For example, the first function 12 is a control function for controlling an existing system and the second function 13 is a control function for controlling a new system integrated into the existing system. The ASIL rank for the first function 12 is ASIL-C and the ASIL rank for the second function is ASIL-D.

A program for carrying out the first function 12 and the second function 13 is stored in a predetermined area in the ROM 27 shown in FIG. 2. The first CPU 11 reads the program and carries out processing and each function of the first function 12 and the second function 13 is thereby carried out. At this time, the first CPU 11 writes and reads data using a predetermined area in the RAM 26 shown in FIG. 2 as a work memory.

At the second level of the first CPU 11, a first monitoring function 14 and a second monitoring function 15 are allocated as illustrated in FIG. 1. The first monitoring function 14 is for monitoring whether the first function 12 required to meet the ASIL-C safety integrity level is correctly working. The second monitoring function 15 is for monitoring the following according to ASIL-C(D) which is one of safety integrity levels, ASIL-C(D) and ASIL-A(D), decomposed from ASIL-D, the safety integrity level required of the second function 13: whether the second function 13 is correctly working. Similarly to the first function 12 and the second function 13, the first monitoring function 14 and the second monitoring function 15 are also comprised of programs that can be executed by the first CPU 11. The programs for carrying out the first monitoring function 14 and the second monitoring function 15 are stored in an area in the ROM 27 different from the storage area for the programs of the first function 12 and the second function 13. When the first CPU 11 executes programs of the first monitoring function 14 and the second monitoring function 15, it writes and reads data using the following predetermined area as a work memory: a predetermined area, different from the area for carrying out the first function 12 and the second function 13, in the RAM 26 shown in FIG. 2.

An example of the concrete detail of programs for carrying out the first monitoring function 14 and the second monitoring function 15 is as described below. The same sensor signals as to the first function 12 and the second function 13 are inputted and the same processing as the first function 12 and the second function 13 is executed to calculate a monitoring control target value. The calculated monitoring control target value is compared with the respective control target values calculated by the first function 12 and the second function 13. In this comparison, the first monitoring function 14 and the second monitoring function 15 determine whether or not the first function 12 and the second function 13 are correctly working according to the following: whether or not the monitoring control target value agrees with the control target values calculated by the first function 12 and the second function 13. Specifically, when the monitoring control target value and the control target values agree with each other, it is determined that the first function 12 and the second function 13 are correctly working; and when they disagree from each other, it is determined that the functions are not correctly working. When it is determined that the first function 12 and the second function 13 are not correctly working, the first monitoring function 14 and the second monitoring function 15 output a stop signal to, for example, a drive circuit, not shown. They thereby stop the output of a driving signal to a device to be controlled based on the control target value.

At the third level of the first CPU 11, a third monitoring function 16 is allocated as illustrated in FIG. 1. The third monitoring function 16 is for monitoring whether or not each of the first monitoring function 14 and the second monitoring function 15 is correctly working. Similarly to the first function 12 and second function 13 and the first monitoring function 14 and second monitoring function 15, the third monitoring function 16 is also comprised of programs that can be executed by the first CPU 11. The programs comprising the third monitoring function 16 are stored in the following area in the ROM 27: an area different from the storage areas for the programs of the first function 12 and second function 13 and the first monitoring function 14 and second monitoring function 15. When the first CPU 11 executes programs of the third monitoring function 16, it writes and reads data using the following area in the RAM 26 as a work memory: a predetermined area different from the areas for carrying out the first function 12, second function 13, first monitoring function 14, and second monitoring function 15.

For example, the third monitoring function 16 determines whether programs comprising the first monitoring function 14 and the second monitoring function 15 are executed at the first CPU 11 in accordance with a correct procedure. This determination is made based on a signal outputted from the first monitoring function 14 and the second monitoring function 15 at each check point. Or, the third monitoring function 16 may determine the following like well-known watchdog timers: whether or not programs comprising the first monitoring function 14 and the second monitoring function 15 are being correctly carried out. This determination is made according to whether or not a signal is periodically outputted from the first monitoring function 14 and the second monitoring function 15. Or, the following may be determined based on a ROM value or a RAM value in the areas used by the first monitoring function 14 and the second monitoring function 15: whether or not each of the first monitoring function 14 and the second monitoring function 15 is correctly working.

When the third monitoring function 16 detects any anomaly in the first monitoring function 14 or the second monitoring function 15, for example, the following takes place: it resets the first monitoring function 14 and the second monitoring function 15 or outputs a stop signal to the above-mentioned drive circuit.

A monitoring IC 17 determines whether the first CPU 11 is correctly operating or any anomaly has occurred through monitoring the third monitoring function 16. When an anomaly has occurred, it resets the first CPU 11. When the first CPU 11 is reset, it is desirable that the monitoring IC 17 should simultaneously output a stop signal to the above-mentioned drive circuit.

For example, the electronic control device is so configured that when the first CPU 11 is correctly executing programs of the third monitoring function 16, the following takes place: a signal varied in predetermined order is outputted from the first CPU 11 to the monitoring IC 17. With this configuration, the monitoring IC 17 can determine the following when a signal outputted from the first CPU 11 is varying in predetermined order: that the first CPU 11 is correctly executing programs of the third monitoring function 16. Meanwhile, when a signal outputted from the first CPU 11 is not varying in predetermined order, the monitoring IC 17 can determine that: the first CPU 11 is not correctly executing programs of the third monitoring function 16 and an anomaly has occurred in the first CPU 11.

A description will be given to the second CPU 21. In the second CPU 21, a safety mechanism according to ASIL-A(D) of the decomposed safety integrity levels is incorporated. The second CPU 21 has a two-level structure. At the first level of the second CPU 21, as illustrated in FIG. 1, a fourth monitoring function 22 is allocated. The fourth monitoring function 22 monitors the following according to ASIL-A(D), one of the decomposed safety integrity levels: whether the second function 13 is correctly working. Similarly to the first monitoring function 14 and the second monitoring function 15, the fourth monitoring function 22 is also comprised of programs that can be executed by the second CPU 21. The programs for carrying out the fourth monitoring function 22 are stored in an area, different from the storage areas for the programs of the other control functions and monitoring functions, in ROM 27. When the second CPU 21 executes programs of the fourth monitoring function 22, it writes and reads data using the following predetermined area in the RAM 26 as a work memory: a predetermined area different from the areas for carrying out the other control functions and monitoring functions.

As a concrete example, the fourth monitoring function 22 can be so configured that the following processing is executed: similarly to the first monitoring function 14 and the second monitoring function 15, the same sensor signal as to the second function 13 is inputted to calculate a monitoring control target value; and it is compared with the control target value calculated by the second function 13. However, the fourth monitoring function 22 is not required so strictly to meet a safety integrity level as the second monitoring function 15 is; therefore, the fourth monitoring function 22 may calculate a monitoring control target value by, for example, simpler processing than in the second monitoring function 15. When processing is simplified as mentioned above, it is required to take an error arising from the simplification into account when the control target value and the monitoring control target value are compared with each other. That is, even though the control target value and the monitoring control target value are different from each other, the fourth monitoring function 22 determines that the second function 13 is correctly working as long as the difference falls within an error range.

At the second level of the second CPU 21, as illustrated in FIG. 1, a fifth monitoring function 23 is allocated. The fifth monitoring function 23 is for monitoring whether or not the fourth monitoring function 22 is correctly working. Similarly to the fourth monitoring function 22, the fifth monitoring function 23 is also comprised of programs that can be executed by the second CPU 21. The programs comprising the fifth monitoring function 23 are stored in an area, different from the storage areas for the programs of the other control functions and monitoring functions, in ROM 27. When the second CPU 21 executes programs of the fifth monitoring function 23, it writes and reads data using the following predetermined area in RAM 26 as a work memory: a predetermined area different from the areas for carrying out the other control functions and monitoring functions. The method for the fifth monitoring function 23 to determine whether the fourth monitoring function 22 is correctly working is the same as the above-mentioned method for the third monitoring function 16 and a description thereof will be omitted.

A watchdog timer (WDT) 24 determines whether the second CPU 21 is correctly operating or any anomaly has occurred through monitoring the fifth monitoring function 23; and when an anomaly has occurred, it resets the second CPU 21. When the second CPU 21 is correctly executing programs of the fifth monitoring function 23, a watchdog pulse is outputted from the second CPU 21 to WDT 24 at predetermined time intervals. Therefore, when a watchdog pulse is outputted from the second CPU 21 at predetermined time intervals, WDT 24 can determine that the second CPU 21 is correctly executing programs of the fifth monitoring function 23. Meanwhile, when a watchdog pulse is not outputted from the second CPU 21 at predetermined time intervals, WDT 24 can determine that: the second CPU 21 is not correctly executing programs of the fifth monitoring function 23 and an anomaly has occurred in the second CPU 21.

When the concept of decomposition is utilized to decompose a higher-order safety integrity level into a plurality of lower-order safety integrity levels, it is required to ensure the independence of decomposed elements. With respect to this, in this embodiment, safety mechanisms according to the decomposed lower-order safety integrity levels are respectively incorporated into independent separate first CPU 11 and second CPU 21 and it is possible to ensure a certain measure of independence.

However, when the CPUs, such as the first CPU 11 and the second CPU 21, are provided in a single microcomputer 10, the following takes place: these CPUs (first CPU 11 and second CPU 21) use RAM 26 and ROM 27 as memories in a shared manner as illustrated in FIG. 2. Therefore, should data required for the execution of a monitoring function by one safety mechanism be read or rewritten during the execution of a monitoring function by the other safety mechanism and interference occur, the following takes place: there is the possibility that a monitoring function will not correctly work. To cope with this, in this embodiment, a memory protection unit (i.e., MPU) 25 is provided between the CPUs 11, 21 and RAM 26 and ROM 27 as illustrated in FIG. 2. The memory areas for each monitoring function are thereby protected against interference. The MPU 25 functions as an anti-interference device.

For example, MPU 25 sets the ranges indicated by alternate long and short dashed lines in FIG. 1 as a range to be protected against interference. That is, MPU 25 inhibits a control function or a monitoring function other than the first monitoring function 14 from doing the following: reading from the ROM area in which the programs of the first monitoring function 14 are stored; and writing and reading data to and from the RAM area specified as the work area for the first monitoring function 14. Similarly, MPU 25 also inhibits the second monitoring function 15 to the fifth monitoring function 23 from doing the following: accessing the memory areas in RAM 26 and ROM 27 ensured for the execution of each monitoring function in conjunction with the execution of other control functions or monitoring functions. This makes it possible to prevent the occurrence of interference and cause each monitoring function to correctly work without fail.

As a result, it is possible to prevent interference with the memory areas ensured for the execution of the fourth monitoring function 22 and the fifth monitoring function 23 in conjunction with the following: the execution of the second monitoring function 15 or the third monitoring function 16 by the first CPU 11. Further, it is also possible to prevent interference with the memory areas ensured for the execution of the second monitoring function 15 and the third monitoring function 16 in conjunction with the following: the execution of the fourth monitoring function 22 or the fifth monitoring function 23 by the second CPU 21. Therefore, it is possible to prevent mutual interference between monitoring functions as safety mechanisms according to decomposed lower-order safety integrity levels without fail and thus it is possible to ensure mutual independence.

Up to this point, a description has been given to a preferred embodiment of the present disclosure. However, the present disclosure is not limited to the above embodiment at all and can be variously modified and embodied without departing from the subject matter of the present disclosure.

(First Modification)

An example will be taken. In the above-mentioned embodiment, using MPU 25, the following is inhibited with respect to each monitoring function: accessing a memory area in RAM 26 or ROM 27 ensured for the execution of each monitoring function in conjunction with the execution of other control functions or monitoring functions. Instead, a measure against interference can also be taken without use of MPU 25. For example, the following function is incorporated into the programs of each monitoring function: a function of, when data is written to a set RAM area, writing the same data to a plurality of locations (identical data writing device). In addition, the following functions are incorporated into some of the programs: a function of determining the identity of data at the locations (determination device); a function of, when it is determined that the identity of data has been lost, inhibiting rewriting the relevant data and keeping the history of interference; and a failsafe function of resetting a higher-order function or outputting a stop signal to a drive circuit according to the history of interference. This also makes it possible to take a measure against interference with respect to each monitoring function.

(Second Modification)

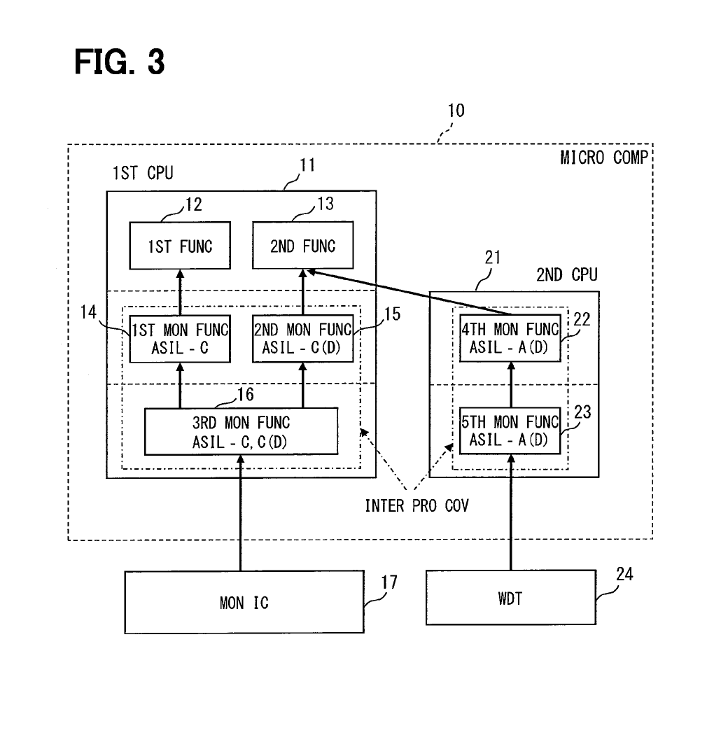

In the above-mentioned embodiment, the WDT 24 built in the microcomputer 10 is utilized to detect whether or not the second CPU 21 is correctly operating. When there is the very low possibility that the second CPU 21 and WDT 24 simultaneously become faulty due to a common cause, it is possible to use the WDT 24 built in the microcomputer 10 as in the above embodiment. However, in consideration of more reliably avoiding the occurrence of a fault due to a common cause, it is desirable that WDT 24 should be separately provided outside the microcomputer 10 as illustrated in FIG. 3.

(Third Modification)

In the above-mentioned embodiment, the first CPU 11 carries out the following functions: the first function 12 that is a control function for controlling an existing system and the second function 13 that is a control function for controlling a new system integrated into the existing system. Further, it carries out each monitoring function as a safety mechanism therefor.

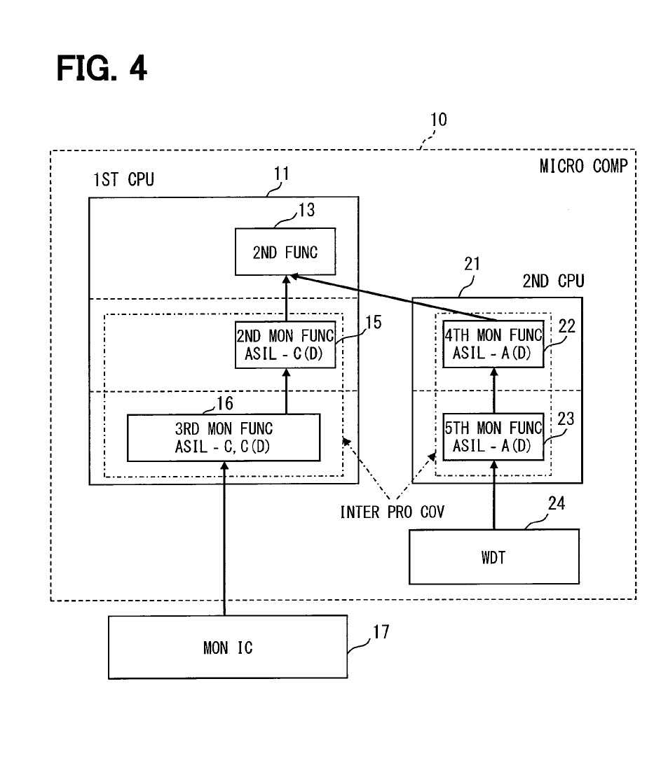

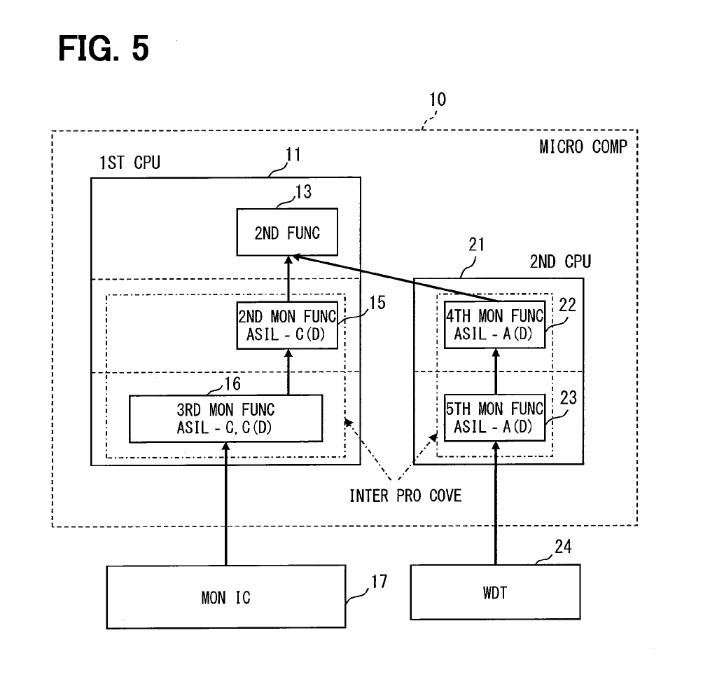

Instead, only the following functions may be incorporated into the first CPU 11 as illustrated in FIG. 4: the second function 13 requiring a safety measure according to a higher-order safety integrity level (for example, ASIL-D); and each monitoring function as a safety mechanism according to one (for example, ASIL-C(D)) of the decomposed safety integrity levels. Further, as illustrated in FIG. 5, WDT 24 may be separately provided outside the microcomputer 10 based on the configuration in FIG. 4.

The electronic control unit may be so configured that the second function 13 is carried out at CPU different from the first CPU 11 and the second CPU 21; and only each monitoring function as a safety mechanism may be incorporated in the first CPU 11 and the second CPU 21.

(Fourth Modification)

In the description of the above embodiment, a case where ASIL-D as a higher-order safety integrity level is decomposed into ASIL-C(D) and ASIL-A(D) has been taken as an example. The present disclosure is also applicable to a case where, for example, ASIL-C is decomposed into ASIL-B(C) and ASIL-A(C) and other like cases.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An electronic control unit for electronically controlling a system, which provides a safety function having a high-order automotive safety integrity level, and for providing a plurality of safety mechanisms having a plurality of low-order automotive safety integrity levels respectively, which are decomposed from the high-order automotive safety integrity level, the electronic control unit comprising:
a plurality of central processing units including a first central processing unit and a second central processing unit;
a memory that is commonly utilized by the plurality of central processing units; and
an anti-interference device,
wherein each of the first central processing unit and the second central processing unit executes a first monitoring function and a second monitoring function as a safety mechanism according to the low-order automotive safety integrity levels, respectively,
wherein the first monitoring function provides to monitor whether a control function of the system is properly executed,
wherein the second monitoring function provides to monitor whether the first monitoring function is properly executed,
wherein the memory has a first area, which is utilized by the first central processing unit to execute each of the first monitoring function and the second monitoring function, and a second area, which is utilized by the second central processing unit to execute each of the first monitoring function and the second monitoring function,
wherein the first area is different from the second area,
wherein the anti-interference device executes at least one of a prevention of an interference and a record of a history of the interference, and
wherein the interference includes a first interference, which is provided to the second area by the first central processing unit when the first central processing unit executes each of the first monitoring function and the second monitoring function, and a second interference, which is provided to the first area by the second central processing unit when the second central processing unit executes each of the first monitoring function and the second monitoring function.

2. The electronic control unit according to claim 1,
wherein the high-order automotive safety integrity level is defined by a functional safety standard of an International Organization for Standardization No. 26262.

3. The electronic control unit according to claim 1,
wherein the anti-interference device includes a memory protection unit, which inhibits accessing the second area when the first central processing unit executes each of the first monitoring function and the second monitoring function and accessing the first area when the second central processing unit executes each of the first monitoring function and the second monitoring function.

4. The electronic control unit according to claim 3,
wherein the memory includes:
a read only memory that stores a software for controlling the first central processing unit and the second central processing unit to execute each of the first monitoring function and the second monitoring function; and
a random access memory that functions as a work memory for executing each of the first monitoring function and the second monitoring function,
wherein each of the read only memory and the random access memory includes the first area and the second area,
wherein the memory protection unit inhibits accessing the second area in the read only memory and the second area in the random access memory when the first central processing unit executes each of the first monitoring function and the second monitoring function, and
wherein the memory protection unit inhibits accessing the first area in the read only memory and the first area in the random access memory when the second central processing unit executes each of the first monitoring function and the second monitoring function.

5. The electronic control unit according to claim 3,
wherein the control function of the system is executed by at least one of the first central processing unit and the second central processing unit,
wherein, when the at least one of the first central processing unit and the second central processing unit executes the control function, the memory protection unit inhibits accessing the first area and the second area in the memory.

6. The electronic control unit according to claim 1,
wherein the memory includes a random access memory as a work memory when each of the first central processing unit and the second central processing unit executes each of the first monitoring function and the second monitoring function,
wherein the random access memory provides the first area and the second area,
wherein the anti-interference device includes:
an identical data writing device that writes identical data to a plurality of locations of the random access memory when data is written to the first area in the random access memory while the first central processing unit executes each of the first monitoring function and the second monitoring function, or when data is written to the second area in the random access memory while the second central processing unit executes each of the first monitoring function and the second monitoring function; and
a determination device that determines whether the data written in the locations are identical, and
wherein, when the data written in the locations are not identical, not-identical data are stored as the history of interference.

7. The electronic control unit according to claim 1, further comprising:
a first monitoring device functioning as the safety mechanism that monitors an operation of the first central processing unit.

8. The electronic control unit according to claim 1, further comprising:
a second monitoring device functioning as the safety mechanism that monitors an operation of the second central processing unit.
